(19) United States
(12) Patent Application Publication
(10) Pub. No.: US 2010/0232641 A1
(43) Pub. Date: Sep. 16, 2010

(54) METHOD AND SYSTEM FOR IDENTIFYING UCC USING IMAGE IDENTIFIER

(76) Inventor: Weon Geun Oh, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/741,195

(22) PCT Filed: Dec. 12, 2008
(86) PCT No.: PCT/KR08/07385

§ 371 Date: May 3, 2010

(30) Foreign Application Priority Data
Dec. 18, 2007 (KR) 10-2007-0133219

(51) Int. Cl. G06K 9/00

(52) U.S. Cl. 382/100

(57) ABSTRACT

There is provided a method of identifying User-Created Content (UCC) using an image identifier, including combining a still image with the image identifier, requesting registration of UCC corresponding to the still image combined with the image identifier, and combining a UCC identifier, issued in response to the request, with the still image combined with the image identifier, thus generating final UCC.

### TECHNICAL FIELD

The present invention relates, in general, to an identification method for image-based User-Created Content (UCC), and, more particularly, to a method and system for identifying UCC, modified in various forms through the movement of content between networks or devices and the editing/processing of content, by utilizing image identifier technology based on concentric division.

This work was supported by the Information and Communication Standard program of MIC/IITA [2007-P10-16, Development of Standards for Digital Rights Management].

### BACKGROUND ART

As well known to those skilled in the art, with the increase in the demand for digital content, a large amount of multimedia content, such as video, music, and images, has been continuously created, produced, transmitted, and serviced.

Among the large amount of multimedia content, content independently created (or processed or edited) by various users is called image-based User-Created Content (UCC). The amount of such image-based UCC (hereinafter referred to as UCC) used has tremendously increased, with the popularization of high-performance and portable digital cameras, large-capacity storage devices and portable storage media, and the decrease in costs thereof.

A method of efficiently identifying various UCC items and recognizing desired UCC as needed is called UCC identification, and a scheme for identifying UCC is called a UCC identification scheme.

A conventional UCC identification scheme is typically configured such that a public institution issues and distributes a unique identifier for content together with metadata information, such as the type, genre, title, file format, author (or contributor) and creation date of content, as in the case of a Universal Content Identifier (UCI) or a Content Object Identifier (COI).

When such an identification scheme is used, desired UCC can be searched for if previously input information, that is, metadata or an identifier, is known.

However, in the conventional case if previously input metadata or an identifier is not known when the UCC identification scheme is utilized, it is very difficult to access desired UCC. Further, there is a problem in that, when the intrinsic characteristics of an image, such as the size, shape or quality thereof, are modified due to variation in the Internet or content players and the processing or reediting of content by a user, there is no a metadata or an identifier information about newly modified content even if the previously input metadata or the previously input identifier is known, thus making it impossible to search for desired UCC.

### DISCLOSURE OF INVENTION

### Technical Solution

It is, therefore, an object of the present invention to provide a method and system for identifying UCC using an image identifier, which can rapidly search for UCC by utilizing both an image identifier, composed of various features of a still image, and an existing identifier even if UCC is modified, or metadata or identifier information does not exist.

In accordance with an embodiment of the present invention, there is provided a method of identifying User-Created Content (UCC) using an image identifier, including combining a still image with the image identifier, requesting registration of UCC corresponding to the still image combined with the image identifier, and combining a UCC identifier, issued in response to the request, with the still image combined with the image identifier, thus generating final UCC. The image identifier is generated using a method including changing a size of the still image to a predetermined size, dividing the still image, the size of which is changed, into a plurality of sections through a concentric division mapping process, generating an average pixel distribution in each annular portion, indicating predetermined sections of the still image divided into the sections, generating a primary variation distribution of the average pixel distribution, and a secondary variation distribution of the average pixel distribution, generating a rotation variation distribution for each annular portion between neighboring sections within the annular portion, and converting the average pixel distribution, the primary variation distribution, the secondary variation distribution and the rotation variation distribution into a bit stream of feature distributions. The dividing the still image to the predetermined size is performed such that a center of the still image, the size of which is changed, is set as a center of concentric circles, the still image is primarily divided into concentric circles having sequentially increasing radiuses, and the still image, divided into the concentric circles, is subsequently divided at regular angles. The conversion into the bit stream is performed using a hash function. The image identifier is implemented as a bit stream of feature distributions including an average pixel distribution, a primary variation distribution of the average pixel distribution, a secondary variation distribution of the average pixel distribution, and a rotation variation distribution.

In accordance with another embodiment of the present invention, there is provided a system for identifying User-Created Content (UCC) using an image identifier, including a still image created by a user, and a digital content registration unit for issuing a UCC identifier in response to a request for registration of UCC corresponding to the still image combined with an image identifier, thus generating final UCC. The image identifier is implemented as a bit stream of feature distributions including an average pixel distribution, a primary variation distribution of the average pixel distribution, a secondary variation distribution of the average pixel distribution, and a rotation variation distribution.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram showing a system for performing a method of identifying UCC using an image identifier in accordance with the present invention;

FIG. 2 is a diagram showing UCC modified in various forms through the movement of content or the editing/processing of content in accordance with the present invention;

FIG. 3 is a flowchart showing a process of generating an image identifier based on concentric division in accordance with the present invention;

FIG. 4 is a diagram showing an image identifier implemented as a bit stream of four feature distributions in accordance with the present invention; and

FIG. 5 is a diagram showing single final UCC in accordance with the present invention.

### BEST MODE FOR CARRYING OUT THE INVENTION

Hereinafter, preferred embodiments of a method of identifying UCC using an image identifier in accordance with the present invention will be described in detail with reference to the accompanying drawings.

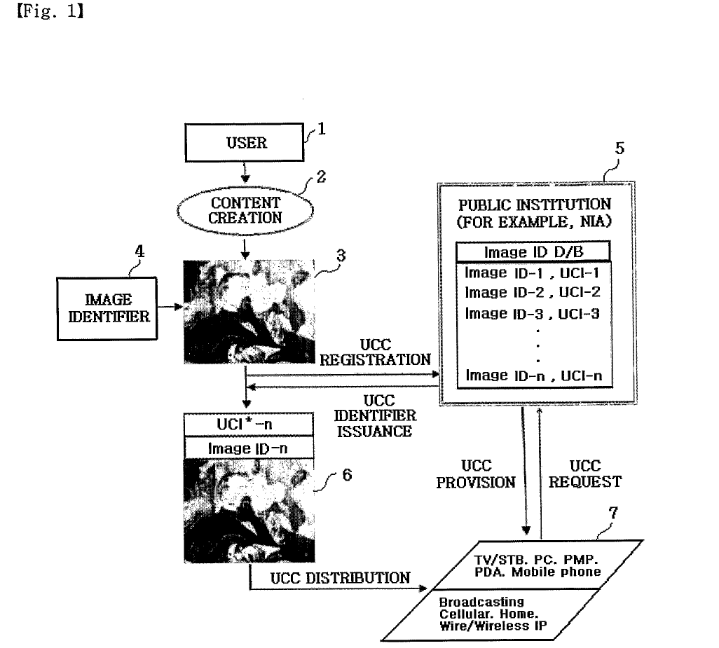

FIG. 1 is a block diagram showing a system for identifying UCC using an image identifier in accordance with the present invention. When a still image 3 created by a user 1 through a content creation process 2 is combined with an image identifier 4 (for example, Image ID-n) in accordance with the present invention, and the registration of UCC corresponding to the still image 3 combined with the image identifier 4 is requested to a digital content registration institution 5 (for example, National Intelligence Authority: NIA), the digital content registration institution 5 issues a UCC identifier (for example, UCI-n) to the still image 3 combined with the image identifier 4, thus finally generating final UCC 6. The final UCC is distributed to a TV/set-top box (STB), PC, Personal Media Player (PMP), Personal Digital Assistant (PDA) or mobile terminal 7, which is based on broadcasting, cellular communication, or home wired/wireless Internet Protocol (IP).

In this case, technology using the image identifier 4 is technology for identifying UCC using the features of all or part of UCC, the intrinsic features of which, for example, the size, shape or quality of an image, are modified due to variation in the Internet or content players, or the processing or reediting of content by a user, and is preferably implemented using concentric division-based still image identification technology.

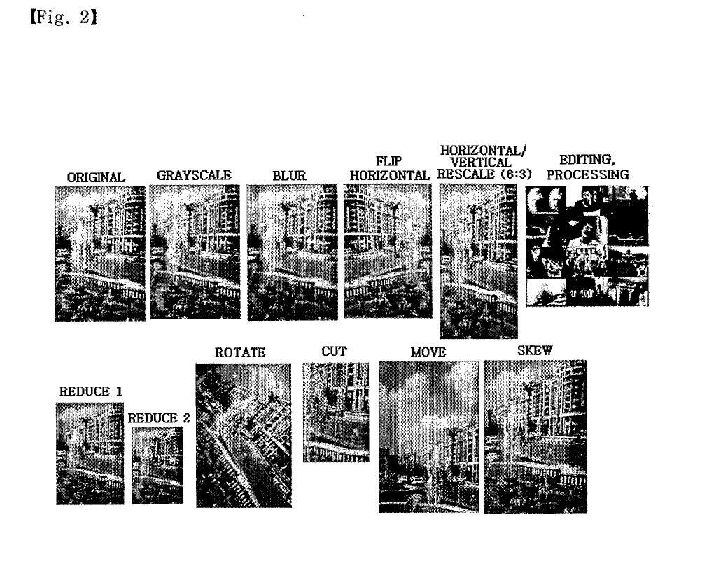

FIG. 2 is a diagram showing UCC modified in various forms through the movement and editing/processing of content in accordance with the present invention, in which an image identifier is generated using the features of respective UCC items.

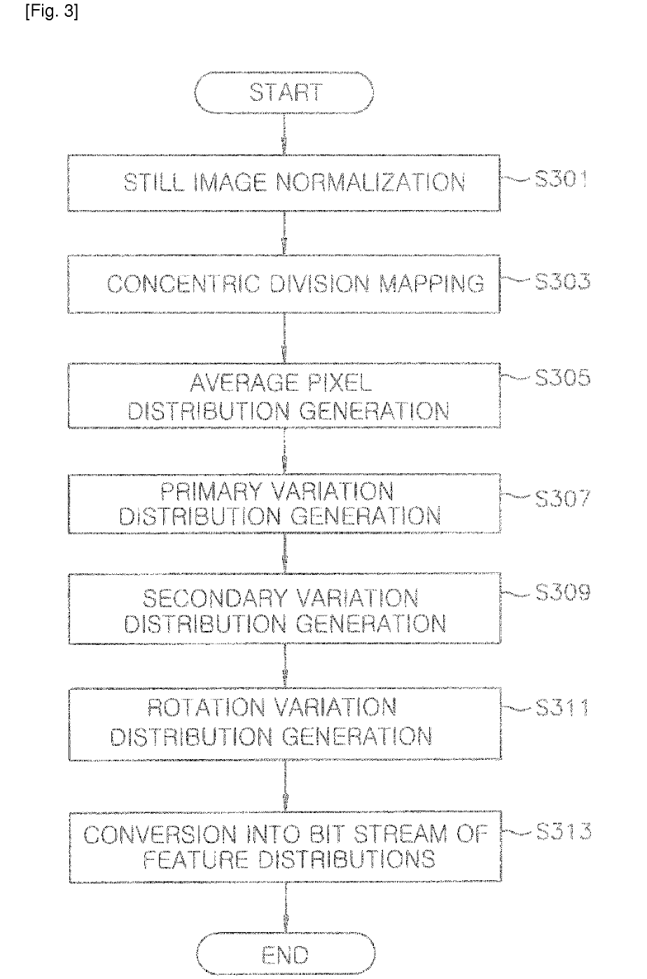

FIG. 3 is a flowchart showing a process of generating an image identifier based on concentric division in accordance with the present invention.

First, the size of a given still image (that is, UCC) is changed to have a certain shape through a still image normalization process at step S301.

Next, the still image normalized at step S301 is divided into a plurality of sections through a concentric division mapping process at step S303.

That is, in order to obtain the features of the still image, the still image normalized at step S301 is divided in the shape of concentric circles in such a way that the center of the still image is set as the center of concentric circles and that the still image is primarily divided into concentric circles having sequentially increasing radiuses, and the still image, divided into the concentric circles, is subsequently divided at regular angles.

Thereafter, for the sections obtained through the division at step S303, the average pixel distribution in each annular portion indicating the predetermined sections is generated through a process of calculating the average pixel distribution of each annular portion at step S305.

Further, a primary variation distribution can be generated for the average pixel distribution generated at step S305 through a process of calculating the primary variation distribution of the average pixel distribution at step S307. A secondary variation distribution can be generated for the average pixel distribution generated at step S305 through a process of calculating the secondary variation distribution of the average pixel distribution at step S309.

Next, the rotation variation distribution for each annular portion is generated between one section and a neighboring section, placed counterclockwise from the section, within the single annular portion through a process of calculating a rotation variation distribution at step S311.

Finally, respective distributions, calculated and generated at the above steps S305, S307, S309 and S311, are converted into a bit stream of feature distributions at step S313, and thus the image identifier can be generated. The conversion into the bit stream may be preferably performed using a hash function.

The image identifier in accordance with the present invention is implemented as a bit stream having a uniform length regardless of the size of the still image that is finally obtained. Accordingly, very high performance is exhibited in the standpoint of the identifier size and matching speed. That is, the final image identifier is configured by individually combining four features, and all features are uniformly obtained from sections divided within respective concentric circles.

Here, the four features may include the primary variation distribution of the average pixel distribution, the secondary variation distribution of the average pixel distribution, the average pixel distribution in each annular portion, and the rotation variation distribution for each annular portion. A single feature value is calculated for each of the annular portions, ranging from the innermost annular portion to the outermost annular portion, and the distributions of these feature values are obtained. Such feature distributions are converted into a bit stream through a simple hash function. One bit is assigned to one annular portion between concentric circles with respect to each of the feature values, so that four bits are occupied for four features on average to said one annular portion.

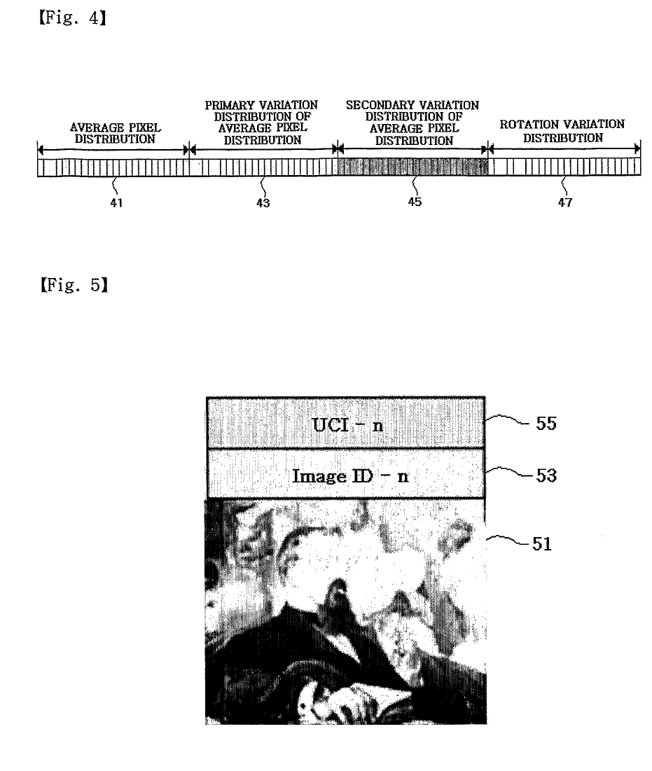

As shown in FIG. 4, the generated image identifier includes a bit stream of four feature distributions, including an average pixel distribution 41, the primary variation distribution 43 of the average pixel distribution, the secondary variation distribution 45 of the average pixel distribution, and a rotation variation distribution 47.

FIG. 5 is a diagram showing single final UCC in accordance with the present invention. When a still image 51 is combined with an image identifier 53 (for example, Image ID-n), which is primary metadata, and then the registration of the still image 51 combined with the image identifier 53 is requested from the digital content registration institution 5 of FIG. 1 (for example, NIA), the digital content registration institution 5 (for example, NIA) issues a UCC identifier 55 (for example, UCI-n) to the still image 51 combined with the image identifier 53 (for example, Image ID-n), thus generating the final UCC of FIG. 5.

As described above, the present invention can implement final UCC generated by issuing the UCC identifier (for example, UCI-n) to the still image combined with the image identifier (for example, Image ID-n), so that, when the implemented UCC is identified, any modified UCC can be identified and searched for using the image identifier (for example, Image ID-n), thus preventing and prohibiting the distribution of illegal content.

The present invention is advantageous in that a large amount of UCC, distributed over image databases or the Internet, or desired UCC can be rapidly and efficiently searched for, and in that modified UCC, the intrinsic features of which, for example, the size, shape or quality of an image, are changed due to the Internet or according to the type of content player, can also be rapidly searched for and identified.

Further, the present invention is advantageous in that, even if a user processes or edits existing content or content created by him or her, the user can search for desired UCC using all or part of the content, and in that, even if UCC is illegally modified due to the duplication of still images or intentional attacks, the user can search for and identify the UCC, thus preventing and prohibiting the illegal distribution of the content.

While the invention has been shown and described with respect to the embodiments, it will be understood by those skilled in the art that various changes and modifications may be made without departing from the scope of the invention as defined in the following claims. Therefore, the scope of the present invention is not limited to the above embodiments, and should be defined by the scope of the claims and equivalents thereof.

1. A method of identifying User-Created Content (UCC) using an image identifier, comprising:
combining a still image with the image identifier;
requesting registration of UCC corresponding to the still image combined with the image identifier; and
combining a UCC identifier, issued in response to the request, with the still image combined with the image identifier, thus generating final UCC.

2. The method of claim 1, wherein the image identifier is generated using a method comprising:
changing a size of the still image to a predetermined size;
dividing the still image, the size of which is changed, into a plurality of sections through a concentric division mapping process;
generating an average pixel distribution in each annular portion, indicating pre-determined sections of the still image divided into the sections;
generating a primary variation distribution of the average pixel distribution, and a secondary variation distribution of the average pixel distribution;
generating a rotation variation distribution for each annular portion between neighboring sections within the annular portion; and
converting the average pixel distribution, the primary variation distribution, the secondary variation distribution and the rotation variation distribution into a bit stream of feature distributions.

3. The method of claim 2, wherein the dividing the still image to the predetermined size is performed such that a center of the still image, the size of which is changed, is set as a center of concentric circles, the still image is primarily divided into concentric circles having sequentially increasing radiuses, and the still image, divided into the concentric circles, is subsequently divided at regular angles.

4. The method of claim 2, wherein the conversion into the bit stream is performed using a hash function.

5. The method of claim 1, wherein the image identifier is implemented as a bit stream of feature distributions including an average pixel distribution, a primary variation distribution of the average pixel distribution, a secondary variation distribution of the average pixel distribution, and a rotation variation distribution.

6. A system for identifying User-Created Content (UCC) using an image identifier, comprising:
a still image created by a user; and
a digital content registration unit for issuing a UCC identifier in response to a request for registration of UCC corresponding to the still image combined with an image identifier, thus generating final UCC.

7. The system of claim 6, wherein the image identifier is implemented as a bit stream of feature distributions including an average pixel distribution, a primary variation distribution of the average pixel distribution, a secondary variation distribution of the average pixel distribution, and a rotation variation distribution.
